(19) United States
(12) Patent Application Publication
(10) Pub. No.: US 2024/0303506 A1
(43) Pub. Date: Sep. 12, 2024

(54) FEATURE EXTRACTION VIA FEDERATED SELF-SUPERVISED LEARNING

(71) Applicant: INTUITIVE SURGICAL OPERATIONS, INC., Sunnyvale, CA (US)

(72) Inventors: Ziheng WANG, Atlanta, GA (US); Conor PERREAULT, Atlanta, GA (US); Xi LIU, Peachtree Corners, GA (US); Anthony M. JARC, Johns Creek, GA (US)

(21) Appl. No.: 18/598,123

(22) Filed: Mar. 7, 2024

Related U.S. Application Data
(60) Provisional application No. 63/489,547, filed on Mar. 10, 2023.

(51) Int. Cl. G06N 3/098; G06N 3/0895

(52) U.S. Cl. CPC G06N 3/098; G06N 3/0895

(57) ABSTRACT

One embodiment of the present invention sets forth a technique for training a machine learning model to perform feature extraction. The technique includes executing a student version of the machine learning model to generate a first set of features from a first set of image crops and executing a teacher version of the machine learning model to generate a second set of features from a second set of image crops. The technique also includes training the student version of the machine learning model based on one or more losses computed between the first and second sets of features. The technique further includes transmitting the trained student version of the machine learning model to a server, wherein the trained student version can be aggregated by the server with additional trained student versions of the machine learning model to generate a global version of the machine learning model.

### RELATED APPLICATIONS

This application claims the benefit of U.S. Provisional Application No. 63/489,547, filed Mar. 10, 2023, and entitled “Feature Extraction via Federated Self-Supervised Learning,” which is incorporated by reference herein.

### BACKGROUND

### Field of the Various Embodiments

Embodiments of the present disclosure relate generally to machine learning and feature extraction and, more specifically, to feature extraction via federated self-supervised learning.

### Description of the Related Art

Surgical data science refers to the capture, organization, analysis, and modeling of data for the purposes of improving the quality, safety, efficiency, and effectiveness of interventional medicine. For example, a surgical data science system could collect data such as videos, sensor data, effector data, and/or vital signals from a patient during a surgical procedure. The surgical data science system could also analyze and/or review the data to extract morphological, anatomical, diagnostic, or functional information; establish different phases or tasks in the surgical procedure; assess the skill or judgment of the surgeon at each phase or task; and/or generate surgical guidance or training materials that are pertinent to specific phases of the procedure, the surgeon, and/or the patient.

Advances in artificial intelligence have allowed machine learning techniques to be used in various surgical data science tasks. For example, deep learning models could be used to identify, semantically segment, and/or track structures or regions of interest within surgical images and/or surgical video; recognize surgical phases and/or other context or activity during surgical procedures; monitor and/or model the usage and motion of surgical tools; and/or detect and track the locations, movement, and/or actions of surgical staff.

However, developing machine learning models to perform surgical data science tasks typically requires large and diverse amounts of labeled surgical data, which can be difficult to acquire for a number of reasons. First, access to surgical data is typically restricted due to data protection laws or policies that apply to sensitive patient information. For this reason, it can be difficult to transfer surgical data from multiple clinical sites into a centralized location for the purpose of training a machine learning model. Moreover, the inability to transfer or share surgical data outside of a clinical site can limit the ability to generate annotations or labels that are used to perform supervised training of the machine learning model, as each clinical site typically has limited resources to perform manual annotation or labeling of the data.

Second, clinical sites can vary in the types of surgical procedures performed and/or the manner in which surgical data from the surgical procedures is collected. These site-specific variations can cause the distributions of surgical data to differ across clinical sites. Consequently, a machine learning model that is trained on surgical data from one clinical site can perform poorly on data from a different clinical site.

As the foregoing illustrates, what is needed in the art are more effective techniques for developing machine learning models that process surgical data and/or other types of sensitive data.

### SUMMARY

One embodiment of the present invention sets forth a technique for training a machine learning model to perform feature extraction. The technique includes executing a student version of the machine learning model to generate a first set of features from a first set of image crops and executing a teacher version of the machine learning model to generate a second set of features from a second set of image crops. The technique also includes training the student version of the machine learning model based on one or more losses computed between the first set of features and the second set of features. The technique further includes transmitting the trained student version of the machine learning model to a server, wherein the trained student version of the machine learning model can be aggregated by the server with additional trained student versions of the machine learning model to generate a global version of the machine learning model.

Consistent with some embodiments, a computer-implemented method for training a machine learning model to perform feature extraction includes executing a student version of the machine learning model to generate a first set of features from a first set of image crops; executing a teacher version of the machine learning model to generate a second set of features from a second set of image crops; training the student version of the machine learning model based on one or more losses computed between the first set of features and the second set of features; and transmitting the trained student version of the machine learning model to a server, wherein the trained student version of the machine learning model can be aggregated by the server with one or more additional trained student versions of the machine learning model to generate a first global version of the machine learning model.

Consistent with some embodiments, a computer-implemented method for training a machine learning model to perform feature extraction includes transmitting a first global version of a machine learning model to a plurality of clients; receiving, from each of the plurality of clients, a corresponding local version of the machine learning model trained based on a student model and a teacher model that are initialized using the first global version of the machine learning model; aggregating the local versions of the machine learning model trained by the plurality of clients into a second global version of the machine learning model; and training the second global version of the machine learning model using a set of input data and a set of labels associated with the set of input data.

Consistent with some embodiments, a computer-implemented method for generating predictions associated with a surgical video includes receiving a global version of a machine learning model, wherein the global version of the machine learning model was generated based on an aggregation of a plurality of local versions of the machine learning model; inputting a sequence of patches extracted from a surgical video into the global version of the machine learning model; executing the global version of the machine learning model to generate predictions of one or more surgical phases or one or more surgical tasks associated with the sequence of patches; and causing the surgical video to be outputted in association with the predictions.

Other embodiments include, without limitation, a system and/or one or more non-transitory machine-readable media including a plurality of machine-readable instructions, which when executed by one or more processors, are adapted to cause the one or more processors to perform any of the methods disclosed herein.

One technical advantage of the disclosed techniques relative to the prior art is that, with the disclosed techniques, a machine learning model can be trained using data at multiple clients without requiring the clients to share and/or transmit the data. Accordingly, the disclosed techniques improve the ability of the machine learning model to generalize to different types of environments or tasks at the clients without compromising the privacy of the data at the clients. Another advantage of the disclosed techniques is the ability to perform self-supervised training of the machine learning model using a relatively large quantity of unlabeled training data at the clients before performing fine-tuning of the machine learning model at the server using a relatively small quantity of labeled training data. Consequently, the disclosed techniques can be used to train a machine learning model to perform supervised learning tasks in a more efficient and less resource-intensive manner than conventional approaches that use large volumes of labeled training data to train machine learning models on supervised learning tasks. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a is a simplified diagram including an example of a computer-assisted system, according to various embodiments.

FIG. 2 illustrates a system for performing federated self-supervised learning, according to various embodiments.

FIG. 3A illustrates an example user interface that is generated based on the execution of a machine learning model that is trained using the system of FIG. 2, according to various embodiments.

FIG. 3B illustrates an example user interface that is generated based on the execution of a machine learning model that is trained using the system of FIG. 2, according to various embodiments.

FIG. 3C illustrates an example user interface that is generated in conjunction with the execution of a machine learning model that is trained using the system of FIG. 2, according to various embodiments.

FIG. 4 is a flow diagram of method steps for coordinating self-supervised training of a machine learning model at a set of clients, according to various embodiments.

FIG. 5 is a flow diagram of method steps for performing self-supervised training of a machine learning model at a client, according to various embodiments.

FIG. 6 is a flow diagram of method steps for analyzing videos of a surgical procedure, according to various embodiments.

### DETAILED DESCRIPTION

This description and the accompanying drawings that illustrate inventive aspects, embodiments, embodiments, or modules should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail in order not to obscure the invention. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Further, the terminology in this description is not intended to limit the invention. For example, spatially relative terms—such as “beneath”, “below”, “lower”, “above”, “upper”, “proximal”, “distal”, and the like—may be used to describe one element's or feature's relationship to another element or feature as illustrated in the figures. These spatially relative terms are intended to encompass different positions (i.e., locations) and orientations (i.e., rotational placements) of the elements or their operation in addition to the position and orientation shown in the figures. For example, if the content of one of the figures is turned over, elements described as “below” or “beneath” other elements or features would then be “above” or “over” the other elements or features. Thus, the exemplary term “below” can encompass both positions and orientations of above and below. A device may be otherwise oriented (rotated 90 degrees or at other orientations) and the spatially relative descriptors used herein interpreted accordingly. Likewise, descriptions of movement along and around various axes include various special element positions and orientations. In addition, the singular forms “a”, “an”, and “the” are intended to include the plural forms as well, unless the context indicates otherwise. And, the terms “comprises”, “comprising”, “includes”, and the like specify the presence of stated features, steps, operations, elements, and/or components but do not preclude the presence or addition of one or more other features, steps, operations, elements, components, and/or groups. Components described as coupled may be electrically or mechanically directly coupled, or they may be indirectly coupled via one or more intermediate components.

Elements described in detail with reference to one embodiment, implementation, or module may, whenever practical, be included in other embodiments, embodiments, or modules in which they are not specifically shown or described. For example, if an element is described in detail with reference to one embodiment and is not described with reference to a second embodiment, the element may nevertheless be claimed as included in the second embodiment. Thus, to avoid unnecessary repetition in the following description, one or more elements shown and described in association with one embodiment, embodiment, or application may be incorporated into other embodiments, embodiments, or aspects unless specifically described otherwise, unless the one or more elements would make an embodiment or embodiment non-functional, or unless two or more of the elements provide conflicting functions.

In some instances, well known methods, procedures, components, and circuits have not been described in detail so as not to unnecessarily obscure aspects of the embodiments.

This disclosure describes various elements (such as systems and devices, and portions of systems and devices) in three-dimensional space. As used herein, the term “position” refers to the location of an element or a portion of an element in a three-dimensional space (e.g., three degrees of translational freedom along Cartesian x-, y-, and z-coordinates). As used herein, the term “orientation” refers to the rotational placement of an element or a portion of an element (three degrees of rotational freedom—e.g., roll, pitch, and yaw). As used herein, the term “pose” refers to the multi-degree of freedom (DOF) spatial position and/or orientation of a coordinate system of interest attached to a rigid body. In general, a pose can include a pose variable for each of the DOFs in the pose. For example, a full 6-DOF pose would include 6 pose variables corresponding to the 3 positional DOFs (e.g., x, y, and z) and the 3 orientational DOFs (e.g., roll, pitch, and yaw). A 3-DOF position only pose would include only pose variables for the 3 positional DOFs. Similarly, a 3-DOF orientation only pose would include only pose variables for the 3 rotational DOFs. Poses with any other number of DOFs (e.g., one, two, four, or five) are also possible. As used herein, the term “shape” refers to a set positions or orientations measured along an element. As used herein, and for an element or portion of an element, e.g., a device (e.g., a computer-assisted system or a repositionable arm), the term “proximal” refers to a direction toward the base of the system or device of the repositionable arm along its kinematic chain, and the term “distal” refers to a direction away from the base along the kinematic chain.

Aspects of this disclosure are described in reference to computer-assisted systems, which may include systems and devices that are teleoperated, remote-controlled, autonomous, semiautonomous, manually manipulated, and/or the like. Example computer-assisted systems include those that comprise robots or robotic devices. Further, aspects of this disclosure are described in terms of an embodiment using a medical system, such as the da Vinci® Surgical System commercialized by Intuitive Surgical, Inc. of Sunnyvale, California. Knowledgeable persons will understand, however, that inventive aspects disclosed herein may be embodied and implemented in various ways, including robotic and, if applicable, non-robotic embodiments. Embodiments described for da Vinci® Surgical Systems are merely exemplary, and are not to be considered as limiting the scope of the inventive aspects disclosed herein. For example, techniques described with reference to surgical instruments and surgical methods may be used in other contexts. Thus, the instruments, systems, and methods described herein may be used for humans, animals, portions of human or animal anatomy, industrial systems, general robotic, or teleoperational systems. As further examples, the instruments, systems, and methods described herein may be used for non-medical purposes including industrial uses, general robotic uses, sensing or manipulating non-tissue work pieces, cosmetic improvements, imaging of human or animal anatomy, gathering data from human or animal anatomy, setting up or taking down systems, training medical or non-medical personnel, and/or the like. Additional example applications include use for procedures on tissue removed from human or animal anatomies (with or without return to a human or animal anatomy) and for procedures on human or animal cadavers. Further, these techniques can also be used for medical treatment or diagnosis procedures that include, or do not include, surgical aspects.

### System Overview

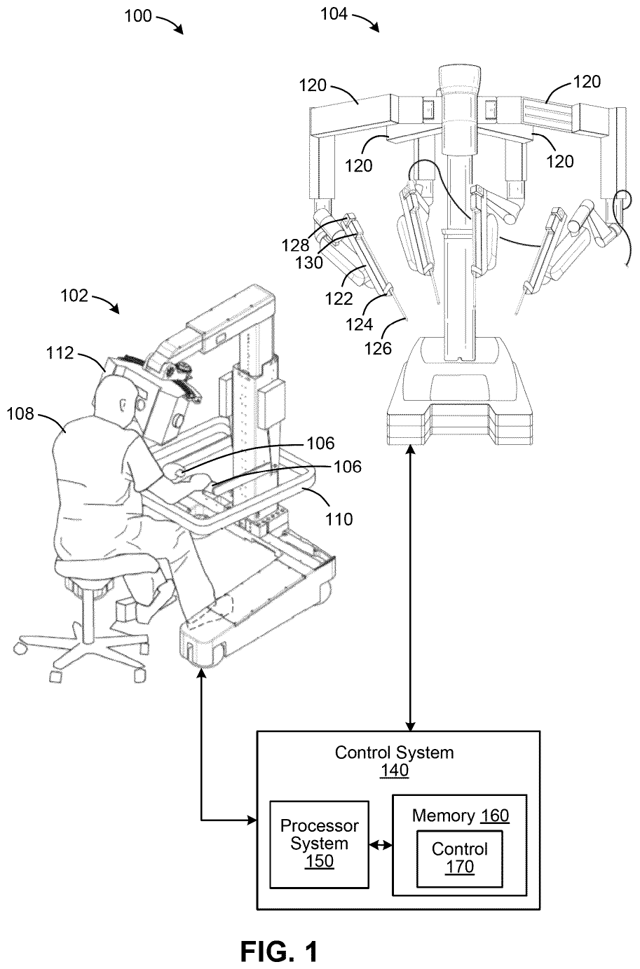

FIG. 1 is a simplified diagram of an example computer-assisted system 100, according to various embodiments. In some examples, the computer-assisted system 100 is a teleoperated system. In medical examples, computer-assisted system 100 can be a teleoperated medical system such as a surgical system. As shown, computer-assisted system 100 includes a follower device 104 that can be teleoperated by being controlled by one or more leader devices (also called “leader input devices” when designed to accept external input), described in greater detail below. Systems that include a leader device and a follower device are referred to as leader-follower systems, and also sometimes referred to as master-slave systems. Also shown in FIG. 1 is an input system that includes a workstation 102 (e.g., a console), and in various embodiments the input system can be in any appropriate form and may or may not include a workstation 102.

In the example of FIG. 1, workstation 102 includes one or more leader input devices 106 that are designed to be contacted and manipulated by an operator 108. For example, workstation 102 can comprise one or more leader input devices 106 for use by the hands, the head, or some other body part(s) of operator 108. Leader input devices 106 in this example are supported by workstation 102 and can be mechanically grounded. In some embodiments, an ergonomic support 110 (e.g., forearm rest) can be provided on which operator 108 can rest his or her forearms. In some examples, operator 108 can perform tasks at a worksite near follower device 104 during a procedure by commanding follower device 104 using leader input devices 106.

A display unit 112 is also included in workstation 102. Display unit 112 can display images for viewing by operator 108. Display unit 112 can be moved in various degrees of freedom to accommodate the viewing position of operator 108 and/or to optionally provide control functions as another leader input device. In the example of computer-assisted system 100, displayed images can depict a worksite at which operator 108 is performing various tasks by manipulating leader input devices 106 and/or display unit 112. In some examples, images displayed by display unit 112 can be received by workstation 102 from one or more imaging devices arranged at a worksite. In other examples, the images displayed by display unit 112 can be generated by display unit 112 (or by a different connected device or system), such as for virtual representations of tools, the worksite, or for user interface components.

When using workstation 102, operator 108 can sit in a chair or other support in front of workstation 102, position his or her eyes in front of display unit 112, manipulate leader input devices 106, and rest his or her forearms on ergonomic support 110 as desired. In some embodiments, operator 108 can stand at the workstation or assume other poses, and display unit 112 and leader input devices 106 can be adjusted in position (height, depth, etc.) to accommodate operator 108.

In some embodiments, the one or more leader input devices 106 can be ungrounded (ungrounded leader input devices being not kinematically grounded, such as leader input devices held by the hands of operator 108 without additional physical support). Such ungrounded leader input devices can be used in conjunction with display unit 112. In some embodiments, operator 108 can use a display unit 112 positioned near the worksite, such that operator 108 manually operates instruments at the worksite, such as a laparoscopic instrument in a surgical example, while viewing images displayed by display unit 112.

Computer-assisted system 100 also includes follower device 104, which can be commanded by workstation 102. In a medical example, follower device 104 can be located near an operating table (e.g., a table, bed, or other support) on which a patient can be positioned. In some medical examples, the worksite is provided on an operating table, e.g., on or in a patient, simulated patient, or model, etc. (not shown). The follower device 104 shown includes a plurality of manipulator arms 120, each manipulator arm 120 configured to couple to an instrument assembly 122. An instrument assembly 122 can include, for example, an instrument 126. In various embodiments, examples of instruments 126 include, without limitation, a scaling instrument, a cutting instrument, a sealing-and-cutting instrument, a suturing instrument (e.g., a suturing needle), a needle instrument (e.g., a biopsy needle), or a gripping or grasping instrument (e.g., clamps, jaws), and/or the like. As shown, each instrument assembly 122 is mounted to a distal portion of a respective manipulator arm 120. The distal portion of each manipulator arm 120 further includes a cannula mount 124 which is configured to have a cannula (not shown) mounted thereto. When a cannula is mounted to the cannula mount, a shaft of an instrument 126 passes through the cannula and into a worksite, such as a surgery site during a surgical procedure. A force transmission mechanism 130 of the instrument assembly 122 can be connected to an actuation interface assembly 128 of the manipulator arm 120 that includes drive and/or other mechanisms controllable from workstation 102 to transmit forces to the force transmission mechanism 130 to actuate the instrument 126.

In various embodiments, one or more of instruments 126 can include an imaging device for capturing images (e.g., optical cameras, hyperspectral cameras, ultrasonic sensors, etc.). For example, one or more of instruments 126 can be an endoscope assembly that includes an imaging device, which can provide captured images of a portion of the worksite to be displayed via display unit 112.

In some embodiments, the manipulator arms 120 and/or instrument assemblies 122 can be controlled to move and articulate instruments 126 in response to manipulation of leader input devices 106 by operator 108, and in this way “follow” the leader input devices 106 through teleoperation. This enables the operator 108 to perform tasks at the worksite using the manipulator arms 120 and/or instrument assemblies 122. Manipulator arms 120 are examples of repositionable structures that a computer-assisted device (e.g., follower device 104) can include. In some embodiments, a repositionable structure of a computer-assisted device can include a plurality of links that are rigid members and joints that are movable components that can be actuated to cause relative motion between adjacent links. For a surgical example, the operator 108 can direct follower manipulator arms 120 to move instruments 126 to perform surgical procedures at internal surgical sites through minimally invasive apertures or natural orifices.

As shown, a control system 140 is provided external to workstation 102 and communicates with workstation 102. In other embodiments, control system 140 can be provided in workstation 102 or in follower device 104. As operator 108 moves leader input device(s) 106, sensed spatial information including sensed position and/or orientation information is provided to control system 140 based on the movement of leader input devices 106. Control system 140 can determine or provide control signals to follower device 104 to control the movement of manipulator arms 120, instrument assemblies 122, and/or instruments 126 based on the received information and operator input. In one embodiment, control system 140 supports one or more wired communication protocols, (e.g., Ethernet, USB, and/or the like) and/or one or more wireless communication protocols (e.g., Bluetooth, IrDA, HomeRF, IEEE 1102.11, DECT, Wireless Telemetry, and/or the like).

Control system 140 can be implemented on one or more computing systems. One or more computing systems can be used to control follower device 104. In addition, one or more computing systems can be used to control components of workstation 102, such as movement of a display unit 112.

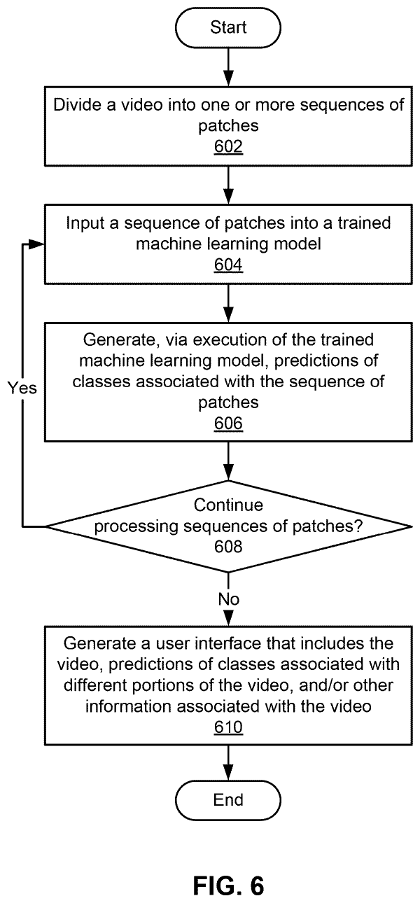

As shown, control system 140 includes a processor system 150 and a memory 160 storing a control module 170. In some embodiments, processor system 150 can include one or more processors, non-persistent storage (e.g., volatile memory, such as random access memory (RAM), cache memory), persistent storage (e.g., a hard disk, an optical drive such as a compact disk (CD) drive or digital versatile disk (DVD) drive, a flash memory, a floppy disk, a flexible disk, a magnetic tape, any other magnetic medium, any other optical medium, programmable read-only memory (PROM), an erasable programmable read-only memory (EPROM), a FLASH-EPROM, any other memory chip or cartridge, punch cards, paper tape, any other physical medium with patterns of holes, etc.), a communication interface (e.g., Bluetooth interface, infrared interface, network interface, optical interface, etc.), and numerous other elements and functionalities. The non-persistent storage and persistent storage are examples of non-transitory, tangible machine readable media that can include executable code that, when run by one or more processors (e.g., processor system 150), can cause the one or more processors to perform one or more of the techniques disclosed herein, including the steps of the method of FIG. 6 described below. In addition, functionality of control module 170 can be implemented in any technically feasible software and/or hardware in some embodiments.

Each of the one or more processors of processor system 150 can be an integrated circuit for processing instructions. For example, the one or more processors can be one or more cores or micro-cores of a processor, a central processing unit (CPU), a microprocessor, a field-programmable gate array (FPGA), an application-specific integrated circuit (ASIC), a digital signal processor (DSP), a graphics processing unit (GPU), a tensor processing unit (TPU), and/or the like. Control system 140 can also include one or more input devices, such as a touchscreen, keyboard, mouse, microphone, touchpad, electronic pen, or any other type of input device.

A communication interface of control system 140 can include an integrated circuit for connecting the computing system to a network (not shown) (e.g., a local area network (LAN), a wide area network (WAN) such as the Internet, mobile network, or any other type of network) and/or to another device, such as another computing system.

Further, control system 140 can include one or more output devices, such as a display device (e.g., a liquid crystal display (LCD), a plasma display, touchscreen, organic LED display (OLED), projector, or other display device), a printer, a speaker, external storage, or any other output device. One or more of the output devices can be the same or different from the input device(s). Many different types of computing systems exist, and the aforementioned input and output device(s) can take other forms.

In some embodiments, control system 140 can be connected to or be a part of a network. The network can include multiple nodes. Control system 140 can be implemented on one node or on a group of nodes. By way of example, control system 140 can be implemented on a node of a distributed system that is connected to other nodes. By way of another example, control system 140 can be implemented on a distributed computing system having multiple nodes, where different functions and/or components of control system 140 can be located on a different node within the distributed computing system. Further, one or more elements of the aforementioned control system 140 can be located at a remote location and connected to the other elements over a network.

Some embodiments can include one or more components of a teleoperated medical system such as a da Vinci® Surgical System, commercialized by Intuitive Surgical, Inc. of Sunnyvale, California, U.S.A. Embodiments on da Vinci® Surgical Systems are merely examples and are not to be considered as limiting the scope of the features disclosed herein. For example, different types of teleoperated systems having follower devices at worksites, as well as non-teleoperated systems, can make use of features described herein.

In some embodiments, control system 140 can record (e.g., log) system states and/or events taking place in computer-assisted system 100. A system state, as used herein, refers to any of: a state of computer-assisted system 100 and/or any component thereof (e.g., instrument 126, manipulator arms 120, an imaging device), any changes to the state of computer-assisted system 100 and/or any component thereof, identification and a current mode/functionality of an instrument 126 in current use, and/or a current parameter under which computer-assisted system 100 and/or a component thereof is operating (e.g., a level of grip force, a level of energy for sealing). An event, as used herein, refers to any of: any interaction between computer-assisted system 100 and a worksite (e.g., an action by instrument 126 on a target in the worksite, whether instrument 126 is contacting an object in the worksite), any action taken by an operator (e.g., operator 108) on computer-assisted system 100 and/or any component thereof (e.g., inputs made by operator 108 into computer-assisted system 100), any output made by computer-assisted system 100 and/or any component thereof (e.g., transmissions between workstation 102, control system 140, and follower device 104). For purposes of simplicity and brevity of this present disclosure, both system states and events are collectively referred to as events. In some embodiments, control module 170 generates an events log, records events in the events log, and stores the events log in a computer readable storage medium (e.g., memory 160).

Instrument 126 includes a proximal end and a distal end. In some embodiments, instrument 126 can have a flexible body. In some embodiments, instrument 126 includes, for example, an imaging device (e.g., an image capture probes), biopsy instrument, laser ablation fibers, and/or other medical surgical, diagnostic, or therapeutic tools. More generally, an instrument 126 can include an end effector and/or tool for performing a task. In some embodiments, a tool included in instrument 126 includes an end effector having a single working member, such as a scalpel, a blunt blade, an optical fiber, an electrode, and/or the like. Other end effectors may include, for example, forceps, graspers, scissors, clip appliers, and/or the like. Other end effectors may further include electrically activated end effectors such as electro surgical electrodes, transducers, sensors, and/or the like.

In some embodiments, instrument 126 can include a sealing instrument for sealing tissue (e.g., a vessel). A sealing instrument can operate according to any technically feasible sealing approach or technique, including for example bipolar sealing, monopolar sealing, or sealing and cutting sequentially or concurrently. Further, the sealing instrument can operate at any technically feasible energy level needed to perform the sealing operation. In some embodiments, an energy level parameter for instrument 126 can be configured or otherwise set by operator 108.

In some embodiments, instrument 126 can include a cutting instrument for cutting tissue. More generally, instrument 126 can include an instrument that can be operated by operator 108 to perform any suitable action in a procedure. In a medical context, such actions include but are not limited to sealing, cutting, gripping, stapling, applying a clip, irrigating, suturing, and so forth.

In some embodiments, instrument 126 can include an instrument that can perform different actions according to different modes, and/or perform an action according to different approaches and/or parameters. For example, a sealing instrument can operate according to a bipolar mode for bipolar sealing or a monopolar mode for monopolar sealing. As another example, a sealing and cutting instrument can include a first mode for sealing and cutting and a second mode for just sealing.

### Feature Extraction Via Federated Self-Supervised Learning

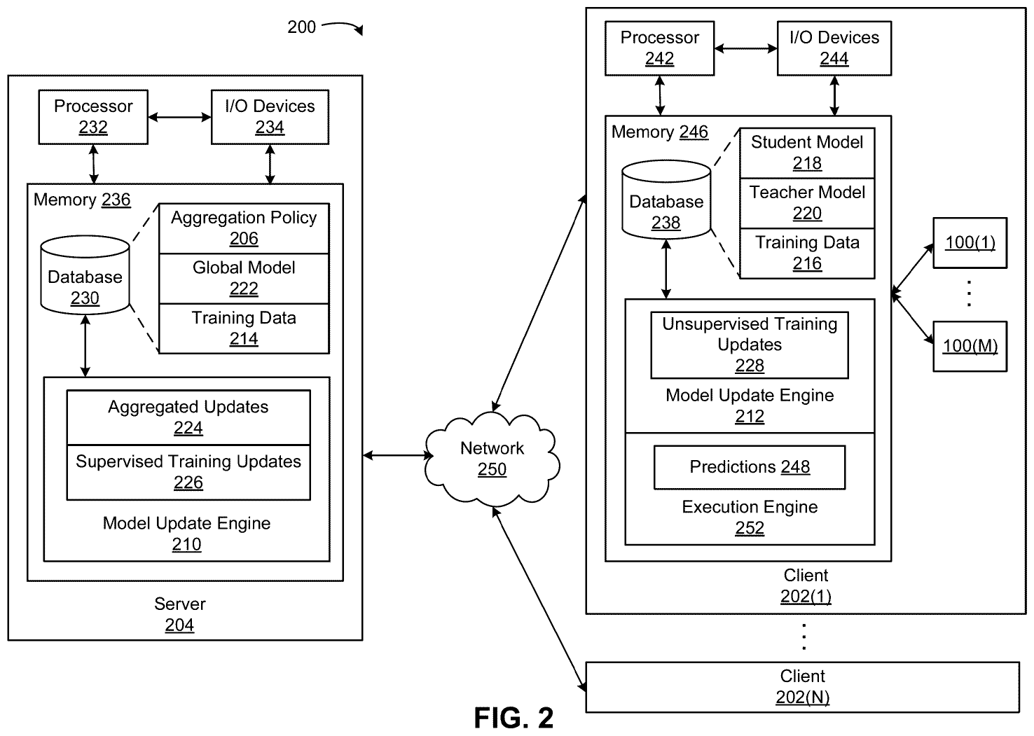

FIG. 2 illustrates a system 200 for performing federated self-supervised learning, according to various embodiments. As shown in FIG. 2, system 200 includes a server 204 that is communicatively coupled to a number of clients 202(1)-202(N) (each of which is referred to individually herein as client 202) via a network 250. Server 204 and clients 202 can be any technically feasible type of computer system, including (but not limited to) a desktop computer, laptop computer, mobile device, game console, workstation, rack-mountable computer system, cluster computer, grid computer, and/or a virtualized instance of a computing device. In some embodiments, one or more instances of server 204 and/or individual clients 202 can execute on one or more nodes of a distributed and/or cloud computing system.

Server 204 and clients 202 are configured to communicate with one another via network 250. For example, network 250 could include (but is not limited to) a wide area network (WAN), local area network (LAN), personal area network (PAN), WiFi network, cellular network, Ethernet network, Bluetooth network, universal serial bus (USB) network, satellite network, and/or the Internet.

Each client 202 includes a processor 242, one or more input/output (I/O) devices 244, and a memory 246, coupled together. Processor 242 includes any technically feasible set of hardware units configured to process data and execute software applications. For example, processor 242 could include one or more CPUs, GPUs, FPGAS, ASICs, DSPs, TPUs, and/or other types of integrated circuits that can be used to process instructions. I/O devices 244 include any technically feasible set of devices configured to perform input and/or output operations, including (but not limited to) a display device, keyboard, touchscreen, mouse, microphone, and/or speaker.

Memory 246 includes any technically feasible storage media configured to store data and software applications. For example, memory 246 could include (but is not limited to) a hard disk, a RAM module, and a ROM module. Memory 246 includes a database 238, a model update engine 212, and an execution engine 252. Database 230 includes a relational database, graph database, key-value store, file system, data warehouse, data storage application, cloud storage, collection of files, and/or another type of data store. Model update engine 212 includes a software application that, when executed by processor 242, interoperates with a corresponding model update engine 210 executing on server 204 to train and/or execute one or more machine learning models. These machine learning models can include (but are not limited to) artificial neural networks, support vector machines, regression models, tree-based models, Bayesian networks, hierarchical models, ensemble models, and/or other types of models configured to perform various types of machine learning tasks.

Server 204 includes a processor 232, one or more I/O devices 234, and a memory 236, coupled together. Processor 232 includes any technically feasible set of hardware units configured to process data and execute software applications. For example, processor 232 could include one or more CPUs, GPUs, FPGAs, ASICs, DSPs, TPUs, and/or other types of integrated circuits that can be used to process instructions. I/O devices 234 include any technically feasible set of devices configured to perform input and/or output operations, including (but not limited to) a display device, keyboard, touchscreen, mouse, microphone, and/or speaker.

Memory 236 includes any technically feasible storage media configured to store data and software applications. For example, memory 236 could include (but is not limited to) a hard disk, a RAM module, and a ROM module. Memory 236 includes a database 230 and a model update engine 210. Database 230 includes a relational database, graph database, key-value store, file system, data warehouse, data storage application, cloud storage, collection of files, and/or another type of data store, similar to database 238. Model update engine 210 includes a software application that, when executed by processor 232, interoperates with model update engine 212 executing on each client 202 to train and/or execute one or more machine learning models. As described above, these machine learning models can include (but are not limited to) artificial neural networks, support vector machines, regression models, tree-based models, Bayesian networks, hierarchical models, ensemble models, and/or other types of models configured to perform various types of machine learning tasks.

In some embodiments, clients 202 correspond to different hospitals and/or clinical sites in which one or more computer-assisted systems 100(1)-100(M) and/or other types of surgical systems are deployed. Each surgical system can include cameras, vital sign monitors, end effectors, inertial sensors, and/or other types of sensors that collect different types of sensor data during a surgical procedure. Machine learning models trained using model update engines 210 and 212 at clients 202 can be used to classify segments of video of surgical procedures into surgical phases of exposure, dissection, transection, extraction, and reconstruction and/or surgical tasks associated with individual surgical phases. These machine learning models can include deep neural networks with a TimeSformer architecture, which leverages a joint space-and-time attention mechanism within each transformer block to learn both spatial and temporal features from the video segments.

Those skilled in the art will appreciate that the sensitive and/or private nature of surgical data generated by hospitals and/or clinical sites can limit access to and/or use of the sensor data to the corresponding client 202. Accordingly, it can be difficult to train robust machine learning models on tasks involving surgical data (or other types of sensitive or private data).

In particular, the inability to transfer or share sensitive or private data outside of a given client 202 can limit the ability to generate annotations or labels that are used to perform supervised training of the machine learning models, as each client 202 typically has limited resources to perform manual annotation or labeling of the data. Further, differences in the distributions of surgical data (or other types of sensitive or private data) from different clients 202 (e.g., due to variations in the types of surgical procedures performed by each client 202, the environments in which the surgical procedures are performed, the manner in which the data is collected, etc.) can cause a machine learning model that is trained on data from one client 202 to perform poorly on data from other clients 202.

To address the above shortcomings, model update engines 210 and 212 include functionality to train one or more machine learning models under a federated self-supervised learning framework. Within the federated self-supervised learning framework, each client 202 establishes a connection over network 250 with server 204. Model update engine 210 executing on server 204 operates according to an aggregation policy 206 associated with the federated self-supervised learning framework. Based on this aggregation policy 206, model update engine 210 initializes a global model 222 for a certain machine learning task and transmits the structure and initial parameters of global model 222 over the corresponding connections to clients 202. Model update engine 212 executing on each client 202 uses global model 222 as a starting point for training a different local model using training data 216 that is generated at that client 202. Additionally, model update engine 212 can use unsupervised training data 216 at the corresponding client 202 to apply unsupervised training updates 228 to the local model at that client 202.

After training of a given local model is complete, the corresponding model update engine 212 transmits parameters of that local model to server 204. Model update engine 212 can also store parameters of the local model with an identifier (e.g., name, version number, timestamp, etc.) for the local model in database 238.

Model update engine 210 receives parameters for different local models from clients 202 and stores each set of parameters with an identifier for the corresponding local model in database 230. After a certain number of local models have been received, a certain amount of time has passed, and/or another condition specified in aggregation policy 206 is met, model update engine 210 performs one or more aggregated updates 224 that aggregate parameters from the local models into a new global model 222 (e.g., according to one or more parameters specified in aggregation policy 206). Model update engine 210 also transmits the new global model 222 to clients 202. After model update engine 212 on a given client 202 receives a new global model 222 from server 204, that model update engine 212 trains a new local model using parameters from the new global model 222 as a starting point. The process repeats until a certain number of “global synchronization rounds” involving the aggregation of a set of local models from clients 202 into an updated global model 222 at server 204 have been performed, parameters of global model 222 converge, one or more losses associated with global model 222 fall below a threshold, and/or another condition specified in aggregation policy 206 is met.

As shown in FIG. 2, each model update engine 212 can train a local model using a student model 218, a teacher model 220, and a set of training data 216 that is generated and/or stored at the corresponding client 202. More specifically, each model update engine 212 can initialize both student model 218 and teacher model 220 to include the parameters and structure of a given version of global model 222 received from server 204.

Each model update engine 212 can also generate training data 216 that includes different representations of data collected or generated by the corresponding client 202. For example, model update engine 212 at each client 202 could generate X “global” views and Y “local” views of videos of surgical procedures performed at that client 202. Each global view could include a crop of a video that includes more than 50% of the pixels within each frame of the video, and each local view could include a crop of a video that includes less than 50% of the pixels within each frame of the video. The crop corresponding to a given global view or local view could include a randomized position, height, and/or width within a given video, subject to any requirements associated with the proportion of pixels in each frame of the video to be included in the crop. A given crop could also, or instead, include a position, height, and/or width that is selected so that the crop captures one or more objects (e.g., surgical instruments, organs, tissue, etc.), activities, and/or other types of detail in the corresponding video and/or portion of a video.

Each model update engine 212 can also input different sets of “views” of training data 216 into student model 218 and teacher model 220. Continuing with the above example, model update engine 212 could generate two global views and eight local views of a given video of a surgical procedure. Model update engine 212 could input the global views and local views into teacher model 220 and use teacher model 220 to convert the inputted views into a first set of feature maps. Update engine 212 could input only the local views into student model 218 and use student model 218 to convert the inputted views into a second set of feature maps.

In general, model update engine 212 can generate multiple types of augmentations to training data 216. Each type of augmentation can include a crop that encompasses more or less than a certain proportion of pixels within each frame of the video. Each type of augmentation can also, or instead, include rotations, scalings, shearings, histogram shifts, additions of noise, and/or other transformations of pixels within video and/or crops of the video. Model update engine 212 could use student model 218 to convert a first set of augmentations of training data 216 into corresponding feature maps. Model update engine 212 could also use teacher model 220 to convert a second set of augmentations of training data 216 into corresponding feature maps. The first set of augmentations and the second set of augmentations can include one or more of the same augmentations. The first set of augmentations (or the second set of augmentations) can also, or instead, include one or more augmentations that are not found in the second set of augmentations (or the first set of augmentations).

Each model update engine 212 additionally trains student model 218 to generate output that mimics that of the corresponding teacher model 220. Continuing with the above example, model update engine 212 could use a training technique (e.g., gradient descent and backpropagation) to update parameters of student model 218 in a way that reduces one or more losses computed between feature maps generated by student model 218 from local views of a given video and feature maps generated by teacher model 220 from local and global views of the same video.

In some embodiments, model update engine 212 does not train teacher model 220 using gradient descent. Instead, model update engine 212 can update parameters of teacher model 220 using an exponential moving average of parameters from student model 218. For example, model update engine 212 could periodically (e.g., every Nth training iteration) compute new parameters of teacher model 220 as a weighted combination of parameters of student model 218 from previous training iterations. Within this weighted combination, weights associated with more recent training iterations could be higher than weights associated with older training iterations.

After a certain number of training iterations has been performed, a given model update engine 212 transmits the latest parameters of the corresponding student model 218 to model update engine 210. Model update engine 210 then aggregates different versions of student model 218 from multiple clients 202 into an update to global model 222 during a corresponding global synchronization round, as discussed above.

An example operation of model update engines 210 and 212 in generating different versions of global model 222, student model 218, and teacher model 220 can be illustrated using the following steps:

```
Input: number of clients [symbol]  , number of global synchronization rounds τ,
learning rate λᵢ for each client i
Output: optimal global model weights \hat{θ}
function ServerUpdate
  initialize global model θ₀
  for round t = 1,2, ... , τ do
    send θₜ₋₁ to all [symbol]   clients
    wait for all [symbol]   clients to finish update
    (Δ_{θ}ⁿ, nᵢ) ← ClientUpdate(θₜ₋₁), i = 1,2, ... , [symbol]
    ${\hat{w}}_{i} ← ( \frac{{n}_{i}}{{\sum }_{i} {n}_{i}} ) * {w}_{i} , {w}_{i} ∈ W , i = 1 , 2 , ... , ℂ$
  aggregate updates \hat{Δ}_{θ,t-1}ⁱ, ← [symbol]   ŵᵢ * Δ_{θ}ⁱ
  θₜ ← θₜ₋₁ + \hat{Δ}_{θ,t-1}ⁱ
  end for
end function
function ClientUpdate (θ)
  U ← unlabeled data pool at at client
  n ← number of total local training iterations
  student θₛ ← global model θ
  teacher θₜ ← global model θ
  for iteration j = 1,2, ... , n do
    ûⱼ^{s} ← Augment(uⱼ), uⱼ ϵ U, student input perturbation
    ûⱼ^{t} ← Augment(uⱼ), uⱼ ϵ U, teacher input perturbation [symbol]
    [(θ, j) ← [symbol]  _{consistency} ( [symbol] (ûⱼ^{s}; θₛ), [symbol]  (ûⱼ^{t}; θₜ))
    optimize loss function θₛ ← θₛ + λᵢ∇ [symbol]  (θ, j)
    update teacher θₜ ← kⱼ * θₛ + (1 − kⱼ) * θᵢ
  end for
  student weight difference Δ_{θ} ← θₛ − θ
  return (Δ_{θ}, n)
end function
```

In the above pseudocode, model update engines 210 and 212 operate according to input parameters that includes a number of clients 202, a number of global synchronization rounds between model update engine 210 and model update engines 212 on clients 202, and a per-client learning rate. These input parameters can be stored and/or specified in aggregation policy 206 and/or another data source.

The pseudocode includes a ServerUpdate function that is performed by model update engine 210 on server 204 and a ClientUpdate function that is performed by model update engine 212 on each client 202. The ServerUpdate function begins with initializing a first version of global model 222 θ₀ to include a certain architecture and set of weights. For example, model update engine 210 could set the architecture of global model 222 to that of a vision transformer, convolutional neural network (CNN), residual neural network, recurrent neural network (RNN), and/or another type of deep neural network. Model update engine 210 could also initialize the weights of global model 222 to randomly generated values and/or to values of weights from a pretrained model (e.g., a neural network that was trained to perform object detection, object tracking, semantic segmentation, action recognition, optical flow estimation, keypoint detection, inpainting, rotation prediction, and/or another type of computer vision task).

After global model 222 is initialized, the ServerUpdate function performs federated training of global model 222 over the specified number (i.e., t) of synchronization rounds. During each synchronization round, the ServerUpdate function transmits the latest global model 222 to clients 202, beginning with the newly initialized global model 222 θ₀ during the first synchronization round. The ServerUpdate function also waits for all or a predetermined number of clients 202 to finish generating updates to global model 222. During this period, the ServerUpdate function receives an update from each client 202 as differences in weights between global model 222 and a corresponding student model 218 trained by model update engine 212 on that client 202.

The ServerUpdate function then aggregates updates received from clients 202 as a weighted sum of the differences. Each weight w; in the weighted sum is associated with a corresponding client 202 denoted by i. Weights in the weighted sum can be set to equal values, determined based on the number of samples used to train the corresponding student models, and/or based on other factors specified in aggregation policy 206.

The ServerUpdate function also generates a new version of global model 222 by adding the weighted sum of updates from clients 202 to the current set of weights for global model 222. The ServerUpdate function then repeats the process with the new version of global model 222 until the specified number of global synchronization rounds has been performed.

The ClientUpdate function is executed using training data 216 U at the corresponding client 202 and a certain number n of local training iterations. The ClientUpdate function begins by initializing student model 218 θₛ and teacher model 220 θₜ using the structure and weights of the most recent global model 222 θ received from server 204. Next, the ClientUpdate function performs local training of student model 218 and teacher model 220 over the n training iterations. During each training iteration, the ClientUpdate function augments a set of samples u; from training data 216 to generate a first set of inputs ûⱼ^{s} for student model 218 and a second set of inputs ûⱼ^{t} for teacher model 220.

As described above, the first set of inputs can include local views of images or video frames in the samples, and the second set of inputs can include both local and global views of the same images or video frames. For example, the first set of inputs ûⱼ^{s} could include multiple sequences of patches extracted from randomized crops of video, where each randomized crop includes less than 50% of the pixels in a corresponding sequence of video frames. The second set of inputs ûⱼ^{t} could include the same sequences of patches as the first set of inputs, as well as additional sequences of patches extracted from larger randomized crops of the same video, where each larger randomized crop includes more than 50% of the pixels in a corresponding sequence of video frames. Each sequence of patches could be denoted by a vector x_{(p,t)}∈ [symbol] ^{3P}^{²}, where each patch has dimensions P×P, p denotes a spatial location of a patch within a given crop of a frame, and t represents an index over frames within a sequence of video.

In some embodiments, the ClientUpdate function performs additional augmentations of samples uⱼ from training data 216 to generate inputs ûⱼ^{s} and/or ûⱼ^{t}. For example, the ClientUpdate function could generate one or both sets of inputs ûⱼ^{s} and/or ûⱼ^{t} by applying color perturbations, rotations, CutMix augmentations, and/or other types of changes to samples uⱼ from training data 216.

The ClientUpdate function also computes a consistency loss between a first set of features generated by student model 218 from the first set of inputs and a second set of features generated by teacher model 220 from the second set of inputs. Continuing with the above example, the ClientUpdate function could input each sequence of patches in the first set of inputs ûⱼ^{s} into a vision transformer corresponding to student model 218. The ClientUpdate function could input each sequence of patches in the second set of inputs ûⱼ^{t} into a vision transformer corresponding to teacher model 220. The ClientUpdate function could then compute the consistency loss as a mean squared error (MSE), L1 loss, L2 loss, and/or another measure of difference between a first feature vector (or map) generated by student model 218 from a first set of patches extracted from a first view of a sequence of video frames and a second feature vector (or map) generated by teacher model 220 from a second set of patches extracted from a second view of the same sequence of video frames. The ClientUpdate function could also, or instead, compute one or more losses between predictions of rotations, clusters, pixel colors, orderings of patches within sequences of video frames, inpainted patches or regions, optical flow, and/or other pseudolabels generated by student model 218 from the first set of inputs and corresponding predictions generated by teacher model 220 from the second set of inputs.

The ClientUpdate function also updates the weights of student model 218 using the gradient of the consistency loss scaled by the learning rate λⱼ for the corresponding client. The ClientUpdate function further updates the weights of teacher model 220 as an exponential moving average of weights from student model 218. In this example, the exponential moving average is computed as the sum of the latest weights from student model 218 scaled by an iteration-dependent value k; and the current weights from teacher model 220 scaled by (1−kⱼ).

After the specified number of training iterations is complete, the ClientUpdate function computes a difference in weights between student model 218 and the version of global model 222 used to initialize student model 218. The ClientUpdate function then returns the difference in weights to server 204 for use in generating a corresponding aggregated update.

As mentioned above, machine learning models trained using system 200 can be used to generate predictions of labels for surgical phases and/or other classes associated with data at clients 202. To enable a given global model 222 to generate predictions of these labels in the absence of labeled training data at clients 202, model update engine 210 uses supervised training data 214 on server 204 to perform one or more rounds of supervised training updates 226 of that global model 222 after federated self-supervised training of global model 222 is complete.

For example, training data 214 could be stored in database 230 on server 204 and include segments of videos of surgical procedures that are mapped to labels that represent surgical phases. After training of global model 222 is complete, model update engine 210 could add a classification head that includes a softmax layer and/or other types of neural network layers to global model 222. Model update engine 210 could also perform one or more rounds of supervised fine-tuning of global model 222 using training data 214. More specifically, model update engine 210 could input various segments of videos from training data 214 into global model 222 and obtain predictions of surgical phases, surgical tasks, and/or other types of classes as corresponding output of the classification head added to global model 222. Model update engine 210 could compute a cross-entropy loss, Kullback-Leibler (KL) divergence, and/or another type of classification loss between the output and the corresponding labels. Model update engine 210 could additionally use a training technique (e.g., gradient descent and backpropagation) to update parameters of global model 222, including the newly added classification head, in a way that reduces the computed losses.

While the operation of system 200 has been described above with respect to training machine learning models to perform tasks related to surgical data at clinical sites, it will be appreciated that system 200 can be used with other environments or contexts involving limited or restricted access to training data for machine learning models. For example, different instances of model update engine 212 could be deployed on edge devices and/or other types of clients 202 that store and/or generate financial data, personal data, manufacturing data, classified data, and/or other types of sensitive or private data. These instances of model update engine 212 could interoperate with model update engine 210 on a centralized server 204 to train one or more machine learning models on tasks related to the data without transmitting or sharing the data outside of the corresponding clients 202.

After training of a given global model 222 is complete, that global model 222 can be used to process additional data at each client 202 and/or at other locations at which the same types of data are generated or stored. More specifically, model update engine 210 and/or server 204 can store different trained versions of global model 222 in database 230. When a new trained version of global model 222 is available (e.g., after federated self-supervised training and supervised fine-tuning of that version is complete), model update engine 210 and/or server 204 can transmit that version to clients 202 and/or the other locations. An instance of execution engine 252 at each location that receives the trained version of global model 222 can execute the new trained version of global model 222 on a real-time, near-real-time, and/or offline basis to generate predictions 248 of classes and/or other attributes associated with data at that location.

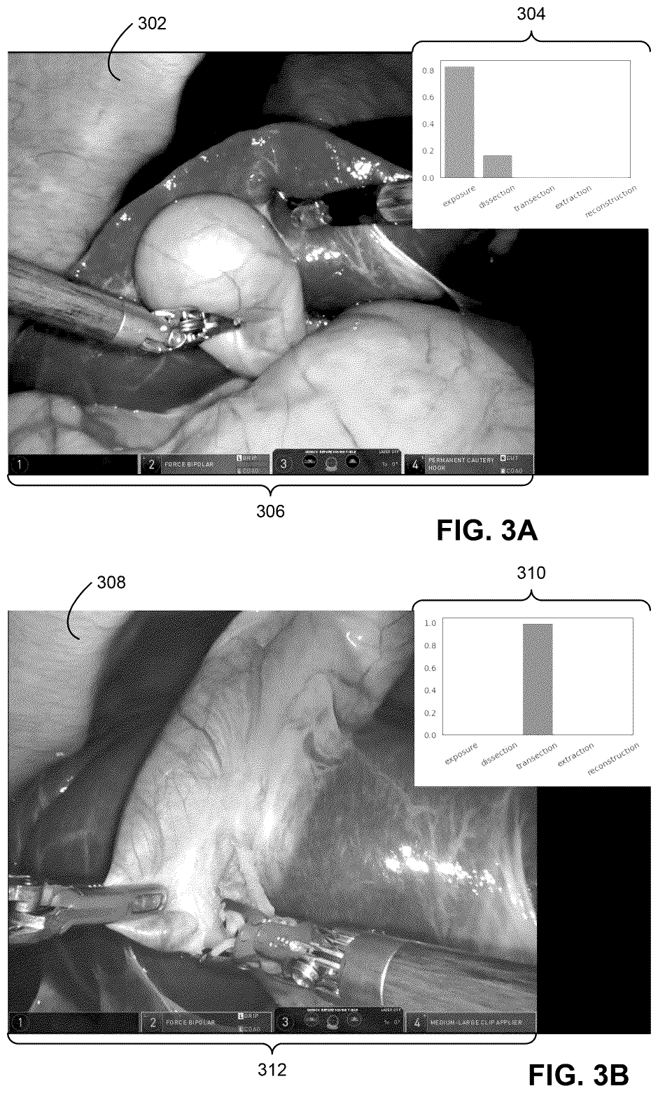

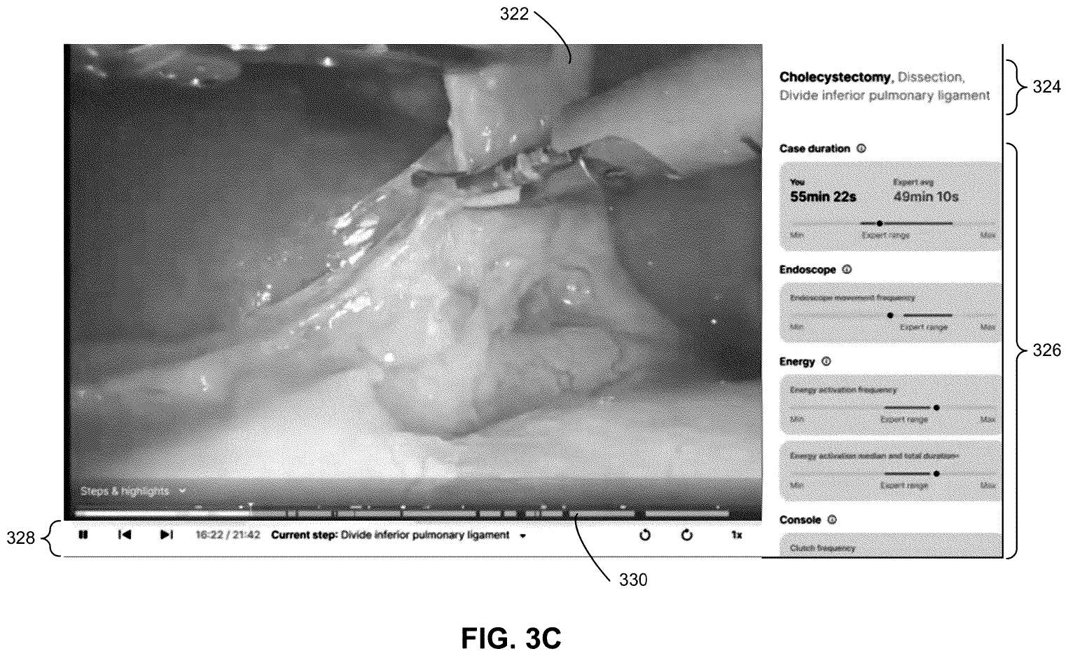

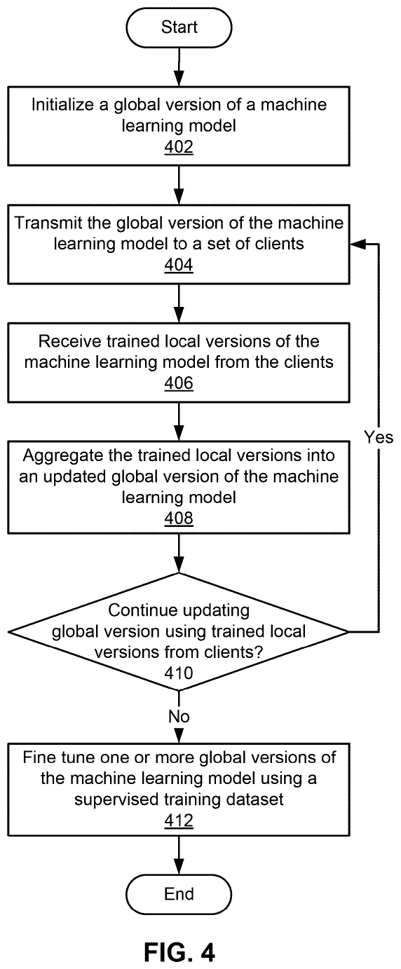

Execution engine 252 can also generate output related to predictions 248 and/or other values produced or processed by the trained version of global model 222. For example, execution engine 252 could generate a user interface that includes a player for surgical videos at the corresponding client 202. The user interface could also include predictions 248 of surgical phases, surgical tasks, and/or other classes associated with a current portion of a surgical video that is shown within the player, as described in further detail below with respect to FIGS. 3A, 3B, and 4. Execution engine 252 could also, or instead, generate and/or output an attention map of patches and/or other regions of the surgical videos. Each attention map could include a heat map visualization of attention weights that are calculated between each patch and all other patches in the same sequence. Within an attention map, the attention weight associated with a patch could be represented by the brightness of the corresponding pixels, where a brighter pixel represents a higher attention weight. The heat map visualization could thus be used to analyze the spatial and temporal relationships used by global model 222 to generate predictions 248.

An instance of model update engine 212 at each location that receives the trained version of global model 222 can also, or instead, use additional training data 216 to perform additional unsupervised training updates 228 in conjunction with the federated self-supervised training framework coordinated by model update engine 210 on server 204. These unsupervised training updates 228 can be aggregated with unsupervised training updates 228 at other clients 202 to generate new versions of global model 222 over time. After each new version of global model 222 is generated, model update engine 210 on server 204 could use training data 214 on server 204 to perform one or more additional rounds of supervised training updates 226 that fine-tune the performance of global model 222 on a classification and/or another type of supervised learning task. Consequently, global model 222 can be adapted to new data and/or tasks as the data and/or labels associated with the tasks become available.

FIG. 3A illustrates an example user interface that is generated based on the execution of a machine learning model that is trained using the system of FIG. 2, according to various embodiments. As shown in FIG. 3A, the user interface includes a frame 302 of a surgical video, as well as a set of predictions 304 of surgical phases associated with frame 302. Predictions 304 include a score of slightly over 0.8 for an “exposure” surgical phase and a score of slightly under 0.2 for a “dissection” surgical phase. Predictions 304 can be generated by dividing frame 302 and/or adjacent frames of the same video into a sequence of patches, using space-and-time attention mechanisms within a series of transformer blocks in the machine learning model to generate spatial and temporal features from the sequence of patches, and using one or more classification layers in the machine learning model to convert the features into the scores included in predictions 304. These predictions 304 can be generated by execution engine 252 using a trained version of the machine learning model, such as a version of global model 222.

The user interface of FIG. 3A also includes status information 306 associated with surgical instruments operated at the time depicted in frame 302. For example, status information 306 could specify the types of surgical instruments used at that time, specific actions performed using the surgical instruments, and/or other data related to the state or usage of the surgical instruments.

FIG. 3B illustrates an example user interface that is generated based on the execution of a machine learning model that is trained using the system of FIG. 2, according to various embodiments. More specifically, FIG. 3B illustrates the user interface of FIG. 3A that is updated to include data for a different frame 308 of the surgical video.

As with FIG. 3A, the updated user interface of FIG. 3B includes frame 308, a set of predictions 310 of surgical phases associated with frame 308, and status information 312 for surgical instruments operated at the time depicted in frame 308. Unlike predictions 304, predictions 310 include a score of close to 1 for a “transection” surgical phase. These predictions 310 reflect differences between the visual content in and around frame 308 and the visual content in and around frame 302.

Status information 312 is similarly updated to reflect the change in context from frame 302 to frame 308. More specifically, status information 312 indicates that the “permanent cautery hook” surgical instrument used at the time depicted in frame 302 has been replaced with a “medium-large clip applier” surgical instrument used at the time depicted in frame 308.

FIG. 3C illustrates an example user interface that is generated based on the execution of a machine learning model that is trained using the system of FIG. 2, according to various embodiments. As shown in FIG. 3C, the user interface includes a frame 322 of a surgical video and a set of attributes 324 associated content depicted in frame 322. Attributes 324 include a surgical procedure of “Cholecystectomy,” a surgical phase of “Dissection,” and a surgical task of “Divide inferior pulmonary ligament.” One or more attributes 324 can be determined based on output generated by the machine learning model from frame 322 and/or adjacent frames in the surgical video. For example, the procedure, surgical phase, and/or surgical task could be predicted by the same machine learning model and/or different machine learning models, given input that includes patches extracted from a sequence of frames that includes frame 322.

The user interface also includes a set of controls 328 related to playback of the surgical video. For example, controls 328 could be used to play the surgical video, pause the surgical video, jump across segments of the surgical video, advance forwards and backwards within the surgical video, and/or set a playback speed for the surgical video.

The user interface additionally includes a temporal breakdown 330 of the surgical video into different labeled segments. Each contiguous “bar” within breakdown 330 can correspond to a different surgical phase, surgical task, and/or another distinct portion of the corresponding surgical procedure, as determined by one or more machine learning models.

The user interface further includes a set of statistics 326 associated with the video. These statistics 326 include, without limitation, the duration of the surgical procedure, an endoscope movement frequency, an energy activation frequency, an energy activation median and total duration, and a clutch frequency. Statistics 326 also include a range of durations and an average duration aggregated from experts performing the procedure for each of the attributes.

FIG. 4 is a flow diagram of method steps for coordinating self-supervised training of a machine learning model at a set of clients, according to various embodiments. Although the method steps are described with respect to the systems of FIGS. 1-2, persons skilled in the art will understand that any system configured to perform the method steps, in any order, falls within the scope of the various embodiments.

As shown, in step 402, model update engine 210 executing on server 204 initializes a global version of a machine learning model. For example, model update engine 210 could initialize neural network layers, blocks, and/or other structures within the machine learning model. Model update engine 210 could also initialize neural network weights of the machine learning model to random values, weights from a pretrained model, and/or weights from a previous version of the machine learning model.

In step 404, model update engine 210 transmits the global version of the machine learning model to a set of clients. For example, model update engine 210 could transmit the global version of a vision transformer to clients corresponding to hospitals, clinical sites, and/or other locations that include images and/or videos of surgical procedures.

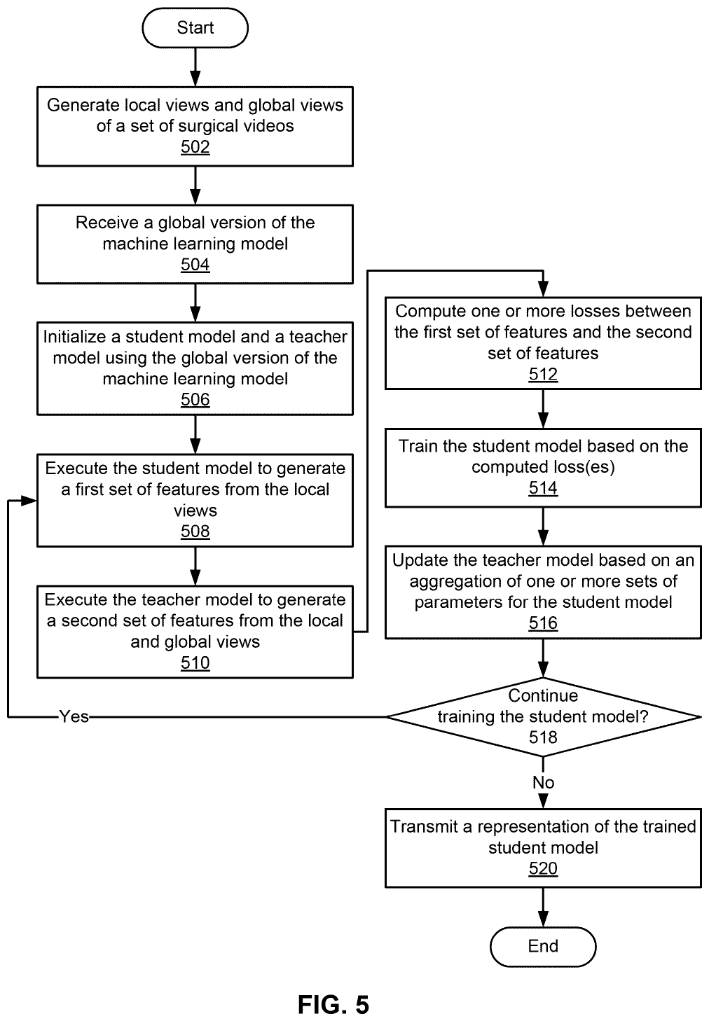

In step 406, model update engine 210 receives trained local versions of the machine learning model from the clients. For example, model update engine 210 could receive each trained local version from a corresponding client after the client has completed training of the machine learning model using a set of training data. The trained local version received from the client could include neural network weights for the trained local version and/or differences between the neural network weights for the trained local version and the neural network weights for the global version. Client-based training of local versions of machine learning models is described in further detail below with respect to FIG. 5.

In step 408, model update engine 210 aggregates the trained local versions into an updated global version of the machine learning model. For example, model update engine 210 could compute a weighted sum of the trained local versions and generate the updated global version by adding the weighted sum to the global version initialized in step 402.

In step 410, model update engine 210 determines whether or not to continue updating the global version of the machine learning model using trained local versions from the clients. For example, model update engine 210 could determine that the global version of the machine learning model is to be updated over a certain number of global synchronization rounds with the clients. While model update engine 210 determines that the global version is to be updated, model update engine 210 repeats steps 402, 404, 406, and 408 to continue generating updated global versions of the machine learning model.

After updating of the global version is complete, model update engine 210 performs step 412, in which model update engine 210 fine tunes one or more global versions of the machine learning model using a supervised training dataset. For example, model update engine 210 could add one or more classification layers to a vision transformer corresponding to a global version of the machine learning model. Model update engine 210 could input sequences of image patches from the supervised training dataset into the global version and use the global version, including the newly added classification layer(s), to generate predictions of classes for each inputted sequence of image patches. Model update engine 210 could also compute one or more losses between the predictions and labels for the corresponding sequences. Model update engine 210 could then use gradient descent and backpropagation to update weights of the global version in a way that minimizes the loss(es). Model update engine 210 can perform this fine-tuning for one or more most recent global versions of the machine learning model, a randomly selected subset of global versions of the machine learning model, one or more global versions with the best performance at a non-classification task, and/or another selection of global versions of the machine learning model.

FIG. 5 is a flow diagram of method steps for performing self-supervised training of a machine learning model at a client, according to various embodiments. Although the method steps are described with respect to the systems of FIGS. 1-2, persons skilled in the art will understand that any system configured to perform the method steps, in any order, falls within the scope of the various embodiments.

As shown, in step 502, model update engine 212 executing on the client generates local views and global views of a set of surgical videos. For example, model update engine 212 could generate local views that include random crops of segments of the surgical videos, where each random crop includes less than a prespecified proportion of pixels within the corresponding segment. Model update engine 212 could also generate global views that include random crops of the same segments of video, where each random crop includes greater than the prespecified proportion of pixels within the corresponding segment.

In step 504, model update engine 212 receives a global version of a machine learning model. For example, model update engine 212 could receive the global version from model update engine 210 executing on server 204.

In step 506, model update engine 212 initializes a student model and a teacher model using the global version of the machine learning model. For example, model update engine 212 could initialize the student model and teacher model as copies of the global version of the machine learning model. Model update engine 212 could also, or instead, initialize the student model and teacher model to be variations of one another and/or the global version of the machine learning model.

In step 508, model update engine 212 executes the student model to generate a first set of features from the local views. In step 510, model update engine 212 executes the teacher model to generate a second set of features from both the local and global views. For example, model update engine 212 could input X local views of a given surgical video into the student model and use the student model to convert the inputted local views into the first set of features. Model update engine 212 could also input the same local views and Y global views of the same surgical video into the teacher model and use the teacher model to convert the inputted local and global views into the second set of features.

In step 512, model update engine 212 computes one or more losses between the first set of features and the second set of features. For example, model update engine 212 could compute a consistency loss that measures the difference between the output generated by the student model from a given view of a surgical video and the output generated by the teacher model from the same view and/or a different view of the same surgical video. In another example, model update engine 212 could compute the consistency loss between a first aggregation of features generated by the student model from multiple local views of a surgical video and a second aggregation of features generated by the teacher model from multiple local views and multiple global views of the same surgical video.

In step 514, model update engine 212 trains the student model based on the computed loss(es). For example, model update engine 212 could use gradient descent and backpropagation to update the parameters of the student model in a way that reduces the loss(es).

In step 516, model update engine 212 updates the teacher model based on an aggregation of one or more sets of parameters for the student model. For example, model update engine 212 could compute new neural network weights for the teacher model as an exponential moving average of neural network weights from the student model.

In step 518, model update engine 212 determines whether or not to continue training the student model. For example, model update engine 212 could determine that the student model is to be trained over a certain number of training iterations. During each training iteration, model update engine 212 could perform steps 508, 510, 512, 514, and 516 to continue inputting various views of the surgical videos into the student model and teacher model, training the student model based on differences in outputs generated by the student model and teacher model from the respective inputs, and updating the teacher model based on parameters of the student model.

After model update engine 212 determines that the student model is no longer to be trained, at step 520 model update engine 212 transmits a representation of the trained student model. For example, model update engine 212 could transmit differences in weights between the trained student model and the global version received in step 504 to model update engine 210 executing on server 204. Model update engine 210 can then use representations of trained student models from multiple clients to generate an updated global version of the machine learning model, as described above with respect to FIG. 4.

FIG. 6 is a flow diagram of method steps for analyzing videos of a surgical procedure, according to various embodiments. Although the method steps are described with respect to the systems of FIGS. 1-2, persons skilled in the art will understand that any system configured to perform the method steps, in any order, falls within the scope of the various embodiments.

As shown, in step 602, execution engine 252 executing on a given client 202 divides a video into one or more sequences of patches. For example, execution engine 252 could divide the video into contiguous and/or overlapping sequences of frames. Within each sequence of frames, execution engine 252 could extract a corresponding sequence of fixed-size patches. The ordering of patches within the sequence of patches could reflect the ordering of the corresponding frames within the video, as well as the spatial locations of the patches within the corresponding frames.

In step 604, execution engine 252 inputs a sequence of patches into a trained machine learning model. For example, execution engine 252 could input the sequence into a vision transformer and/or another type of machine learning model that is capable of processing images and/or video. The machine learning model could be trained using the federated self-supervised learning framework described above.

In step 606, execution engine 252 generates, via execution of the trained machine learning model, predictions of classes associated with the sequence of patches. For example, execution engine 252 could use a series of transformer blocks to determine spatial and temporal relationships across tokens representing the sequence of patches. Execution engine 252 could also use one or more classification layers to convert a classification token outputted by the series of transformer blocks into predicted probabilities of classes representing surgical phases, surgical tasks, and/or other attributes that are relevant to the content of surgical videos.

In step 608, execution engine 252 determines whether or to not to continue processing sequences of patches. For example, execution engine 252 could determine that sequences of patches should continue to be processed while the trained machine learning model has not been used to generate predictions for all sequences of patches produced in step 602. While additional sequences of patches remain to be processed, execution engine 252 repeats steps 604 and 606 to generate predictions of classes for each of these sequences of patches.

After the trained machine learning model has been used to generate predictions of classes for all sequences of patches extracted from the video, execution engine 252 performs step 610, in which execution engine 252 generates a user interface that includes the video, predictions of classes associated with different portions of the video, and/or additional information associated with the video, such as is shown in FIGS. 3A, 3B, and 3C. For example, execution engine 252 could include, within the user interface, one or more user-interface elements that can be used to play, pause, scrub, advance forward, advance backwards, and/or otherwise control playback of the video. Execution engine 252 could also display, for the portion of the video that is currently being played, predictions of surgical phases, surgical tasks, and/or other attributes associated with that portion. Execution engine 252 could also, or instead, display statistics associated with the portion of the video and/or the video as a whole.

In sum, the disclosed techniques use a federated self-supervised learning framework to train machine learning models on tasks involving surgical videos and/or other sensitive or private data. The federated self-supervised learning framework includes multiple clients and a centralized server. Each client performs self-supervised training of a corresponding local version of a machine learning model using data that is generated and/or stored at that client. For example, each client could include a hospital, clinical site, and/or another location at which surgical data is generated. Each client could initialize a student model and a teacher model using a global model from the server. Each client could also generate different types of views of the surgical data, such as randomized crops of surgical videos that include greater than or less than a threshold proportion of pixels within frames of the surgical videos. The client could use the student model to convert a first set of crops of a given video into a first set of features. The client could also use the teacher model to convert a second set of crops of the same video into a second set of features. The client could train the student model using a consistency loss between the first set of features and the second set of features, so that features generated by the student model from certain types of crops of a given video resemble features generated by the teacher model from certain other types of crops of the same video. The client could also update parameters of the teacher model as an exponential moving average and/or another aggregation of different sets of parameters for the student model that are generated over a series of training iterations.

The server coordinates training of local versions of the machine learning model across the clients and aggregates the local versions of the machine learning model into different versions of the global model. For example, the server could initialize a first version of the global model using randomized parameters and/or parameters from a pre-trained model. The server could transmit the first version of the global model to the clients as a starting point for training the corresponding local versions of the machine learning model. After the local versions of the machine learning model have been returned by the clients, the server could update the global model using a weighted sum of the local versions from the clients. Weights used in the weighted sum could be equal to one another, computed based on the amount of training data at each client, and/or determined based on other factors. The server could repeat the process over a number of synchronization rounds to generate a corresponding number of versions of the global model. The server could also perform supervised fine-tuning of one or more versions of the global model using labeled surgical videos available at the server. The server could then provide the fine-tuned version(s) of the global model to the clients to allow the clients to use the global model to generate predictions of classes for surgical videos and/or other types of surgical data at the clients.

One technical advantage of the disclosed techniques relative to the prior art is that, with the disclosed techniques, a machine learning model can be trained using data at multiple clients without requiring the clients to share and/or transmit the data. Accordingly, the disclosed techniques improve the ability of the machine learning model to generalize to different types of environments or tasks at the clients without compromising the privacy of the data at the clients. Another advantage of the disclosed techniques is the ability to perform self-supervised training of the machine learning model using a relatively large quantity of unlabeled training data at the clients before performing fine-tuning of the machine learning model at the server using a relatively small quantity of labeled training data. Consequently, the disclosed techniques can be used to train a machine learning model to perform supervised learning tasks in a more efficient and less resource-intensive manner than conventional approaches that use large volumes of labeled training data to train machine learning models on supervised learning tasks. These technical advantages provide one or more technological improvements over prior art approaches.
1. In some embodiments, a computer-implemented method for training a machine learning model to perform feature extraction comprises executing a student version of the machine learning model to generate a first set of features from a first set of image crops; executing a teacher version of the machine learning model to generate a second set of features from a second set of image crops; training the student version of the machine learning model based on one or more losses computed between the first set of features and the second set of features; and transmitting the trained student version of the machine learning model to a server, wherein the trained student version of the machine learning model can be aggregated by the server with one or more additional trained student versions of the machine learning model to generate a first global version of the machine learning model.
2. The computer-implemented method of clause 1, further comprising receiving a second global version of the machine learning model from the server; and initializing the student version of the machine learning model and the teacher version of the machine learning model based on the second global version of the machine learning model.
3. The computer-implemented method of any of clauses 1-2, wherein the second global version of the machine learning model comprises at least one of a pre-trained machine learning model, a randomly initialized machine learning model, or an aggregation of a previous set of student versions of the machine learning model.
4. The computer-implemented method of any of clauses 1-3, further comprising updating parameters of the teacher version of the machine learning model using an exponential moving average of one or more sets of parameters for the student version of the machine learning model.
5. The computer-implemented method of any of clauses 1-4, further comprising generating the first set of image crops to include a first set of regions within a set of surgical videos; and generating the second set of image crops to include the first set of regions and a second set of regions within the set of surgical videos.
6. The computer-implemented method of any of clauses 1-5, wherein each region included in the first set of regions occupies less than half of a video frame within the set of surgical videos.
7. The computer-implemented method of any of clauses 1-6, wherein each region included in the second set of regions occupies greater than half of a video frame within the set of surgical videos.
8. The computer-implemented method of any of clauses 1-7, further comprising generating the first set of image crops to include one or more objects depicted within a set of videos.
9. The computer-implemented method of any of clauses 1-8, further comprising receiving the first global version of the machine learning model from the server; and executing the first global version of the machine learning model to generate a set of predictions from a set of surgical videos.
10. The computer-implemented method of any of clauses 1-9, further comprising generating a user interface that includes a player for a video included in the set of surgical videos; and a prediction of one or more classes associated with one or more portions of the video, wherein the prediction is generated by the first global version of the machine learning model based on the set of surgical videos.
11. The computer-implemented method of any of clauses 1-10, wherein the set of predictions comprises at least one of a surgical phase or a surgical task.
12. The computer-implemented method of any of clauses 1-11, wherein the one or more losses comprise a consistency loss between the first set of features and the second set of features.
13. The computer-implemented method of any of clauses 1-12, wherein the first global version of the machine learning model comprises a vision transformer.
14. In some embodiments, a computer-implemented method for training a machine learning model to perform feature extraction comprises transmitting a first global version of a machine learning model to a plurality of clients; receiving, from each of the plurality of clients, a corresponding local version of the machine learning model trained based on a student model and a teacher model that are initialized using the first global version of the machine learning model; aggregating the local versions of the machine learning model trained by the plurality of clients into a second global version of the machine learning model; and training the second global version of the machine learning model using a set of input data and a set of labels associated with the set of input data.
15. The computer-implemented method of clause 14, further comprising transmitting a third global version of the machine learning model to the plurality of clients; and generating the first global version of the machine learning model based on additional local versions of the machine learning model trained by the plurality of clients based on the third global version of the machine learning model.
16. The computer-implemented method of any of clauses 14-15, wherein aggregating the local versions of the machine learning model comprises computing a weighted sum of the local versions of the machine learning model.
17. The computer-implemented method of any of clauses 14-16, wherein computing the weighted sum comprises determining a weight associated with a local version of the machine learning model based on a quantity of training data used to train the local version of the machine learning model.
18. The computer-implemented method of any of clauses 14-17, wherein the plurality of clients comprises at least one of a hospital or a clinical site.
19. The computer-implemented method of any of clauses 14-18, wherein the set of input data comprises a set of surgical videos.
20. The computer-implemented method of any of clauses 14-19, wherein the set of labels comprises a set of surgical phases or a set of surgical tasks.
21. In some embodiments, a computer-implemented method for generating predictions associated with a surgical video comprises receiving a global version of a machine learning model, wherein the global version of the machine learning model was generated based on an aggregation of a plurality of local versions of the machine learning model; inputting a sequence of patches extracted from a surgical video into the global version of the machine learning model; executing the global version of the machine learning model to generate predictions of one or more surgical phases or one or more surgical tasks associated with the sequence of patches; and causing the surgical video to be outputted in association with the predictions.
22. The computer-implemented method of clause 21, wherein causing the surgical video to be outputted in association with the predictions comprises generating a user interface that includes a player for the surgical video; and the predictions of the one or more surgical phases or the one or more surgical tasks associated with a portion of the surgical video corresponding to the sequence of patches.
23. The computer-implemented method of any of clauses 21-22, wherein the user interface further includes a set of statistics associated with the surgical video.
24. The computer-implemented method of any of clauses 21-23, wherein the user interface further includes a set of statistics associated with a category of surgical videos to which the surgical video belongs.
25. The computer-implemented method of any of clauses 21-24, further comprising extracting the sequence of patches from a sequence of frames included in the surgical video.
26. The computer-implemented method of any of clauses 21-25, wherein executing the global version of the machine learning model comprises executing one or more transformer blocks included in the global version of the machine learning model to generate a plurality of tokens representing the sequence of patches; and applying one or more classification layers included in the global version of the machine learning model to one or more tokens included in the plurality of tokens to generate the predictions of the one or more surgical phases or the one or more surgical tasks.
27. In some embodiments, one or more non-transitory computer-readable media store instructions that, when executed by one or more processors, cause the one or more processors to perform the method of any one of clauses 1-26.
28. In some embodiments, a system comprises one or more memories that store instructions, and one or more processors that are coupled to the one or more memories and, when executing the instructions, are configured to perform the method of any one of clauses 1-26.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a machine learning model to perform feature extraction, the method comprising:
executing a student version of the machine learning model to generate a first set of features from a first set of image crops;
executing a teacher version of the machine learning model to generate a second set of features from a second set of image crops;
training the student version of the machine learning model based on one or more losses computed between the first set of features and the second set of features; and
transmitting the trained student version of the machine learning model to a server, wherein the trained student version of the machine learning model can be aggregated by the server with one or more additional trained student versions of the machine learning model to generate a first global version of the machine learning model.

2. The computer-implemented method of claim 1, further comprising:
receiving a second global version of the machine learning model from the server; and
initializing the student version of the machine learning model and the teacher version of the machine learning model based on the second global version of the machine learning model.

3. The computer-implemented method of claim 2, wherein the second global version of the machine learning model comprises at least one of a pre-trained machine learning model, a randomly initialized machine learning model, or an aggregation of a previous set of student versions of the machine learning model.

4. The computer-implemented method of claim 1, further comprising updating parameters of the teacher version of the machine learning model using an exponential moving average of one or more sets of parameters for the student version of the machine learning model.

5. The computer-implemented method of claim 1, further comprising:
generating the first set of image crops to include a first set of regions within a set of surgical videos; and
generating the second set of image crops to include the first set of regions and a second set of regions within the set of surgical videos.

6. The computer-implemented method of claim 5, wherein:
each region included in the first set of regions occupies less than half of a video frame within the set of surgical videos; or
each region included in the second set of regions occupies greater than half of a video frame within the set of surgical videos.

7. The computer-implemented method of claim 1, further comprising:
receiving the first global version of the machine learning model from the server; and
executing the first global version of the machine learning model to generate a set of predictions from a set of surgical videos;
wherein the set of predictions comprises at least one of a surgical phase or a surgical task.

8. The computer-implemented method of claim 7, further comprising generating a user interface that includes:
a player for a video included in the set of surgical videos; and
a prediction of one or more classes associated with one or more portions of the video, wherein the prediction is generated by the first global version of the machine learning model based on the set of surgical videos.

9. A computer-implemented method for training a machine learning model to perform feature extraction, the method comprising:
transmitting a first global version of a machine learning model to a plurality of clients;
receiving, from each of the plurality of clients, a corresponding local version of the machine learning model trained based on a student model and a teacher model that are initialized using the first global version of the machine learning model;
aggregating the local versions of the machine learning model trained by the plurality of clients into a second global version of the machine learning model; and
training the second global version of the machine learning model using a set of input data and a set of labels associated with the set of input data.

10. The computer-implemented method of claim 9, further comprising:
transmitting a third global version of the machine learning model to the plurality of clients; and
generating the first global version of the machine learning model based on additional local versions of the machine learning model trained by the plurality of clients based on the third global version of the machine learning model.

11. The computer-implemented method of claim 9, wherein aggregating the local versions of the machine learning model comprises computing a weighted sum of the local versions of the machine learning model.

12. The computer-implemented method of claim 11, wherein computing the weighted sum comprises determining a weight associated with a local version of the machine learning model based on a quantity of training data used to train the local version of the machine learning model.

13. The computer-implemented method of claim 9, wherein the set of input data comprises a set of surgical videos.

14. The computer-implemented method of claim 9, wherein the set of labels comprises a set of surgical phases or a set of surgical tasks.

15. One or more non-transitory computer-readable media storing instructions that, when executed by one or more processors, cause the one or more processors to perform a method comprising:
executing a student version of a machine learning model to generate a first set of features from a first set of image crops;
executing a teacher version of the machine learning model to generate a second set of features from a second set of image crops;
training the student version of the machine learning model based on one or more losses computed between the first set of features and the second set of features; and
transmitting the trained student version of the machine learning model to a server, wherein the trained student version of the machine learning model can be aggregated by the server with one or more additional trained student versions of the machine learning model to generate a first global version of the machine learning model.

16. The one more non-transitory computer-readable media of claim 15, wherein the method further comprises:
receiving a second global version of the machine learning model from the server; and
initializing the student version of the machine learning model and the teacher version of the machine learning model based on the second global version of the machine learning model.

17. The one more non-transitory computer-readable media of claim 16, wherein the second global version of the machine learning model comprises at least one of a pre-trained machine learning model, a randomly initialized machine learning model, or an aggregation of a previous set of student versions of the machine learning model.

18. The one more non-transitory computer-readable media of claim 15, wherein the method further comprises updating parameters of the teacher version of the machine learning model using an exponential moving average of one or more sets of parameters for the student version of the machine learning model.

19. The one more non-transitory computer-readable media of claim 15, wherein the method further comprises:
generating the first set of image crops to include a first set of regions within a set of surgical videos; and
generating the second set of image crops to include the first set of regions and a second set of regions within the set of surgical videos.

20. The one more non-transitory computer-readable media of claim 15, wherein the method further comprises:
receiving the first global version of the machine learning model from the server; and
executing the first global version of the machine learning model to generate a set of predictions from a set of surgical videos;
wherein the set of predictions comprises at least one of a surgical phase or a surgical task.
